(19) United States
(12) Patent Application Publication
(10) Pub. No.: US 2006/0180769 A1
(43) Pub. Date: Aug. 17, 2006

(54) Adapter for a detector and method for carrying out faultfinding on a detector having such an adapter

(75) Inventors: Peter Hackenschmied, Nuernberg (DE); Thomas Hilderscheid, Altdorf (DE); Harald Maerkl, Gerhardshofen (DE)

Correspondence Address: HARNESS, DICKEY & PIERCE, P.L.C., P.O.BOX 8910, RESTON, VA, 20195, US

(73) Assignee: Siemens AG

(21) Appl. No.: 11/355,890

(22) Filed: Feb. 17, 2006

(30) Foreign Application Priority Data
Feb. 17, 2005 (DE) 10 2005 007 485.5

(51) Int. Cl. G01T 1/24

(52) U.S. Cl. 250/370.09

(57) ABSTRACT

An adapter is disclosed for a detector including a plurality of detector modules. A method is further disclosed for carrying out faultfinding on the detector including such an adapter. It is possible for an electrical cross-connection to be produced between at least one first detector module and a second slot on a printed circuit board, and between a second detector module and a first slot of the printed circuit board by use of the adapter. The adapter makes possible simple and rapid faultfinding of a defective component of the detector by way of a first and a second measurement, in which measurements a position of the faulty output signal is determined.

The present application hereby claims priority under 35 U.S.C. §119 on German patent application number DE 10 2005 007 485.5 filed Feb. 17, 2005, the entire contents of which is hereby incorporated herein by reference.

### FIELD

The invention generally relates to an adapter for a detector. The adapter may include, for example, a plurality of detector modules which can be brought into contact with a printed circuit board. The invention also generally relates to a method for carrying out faultfinding on such a detector having such an adapter.

### BACKGROUND

DE 101 35 288 A1 has disclosed a detector for a computer tomograph which includes a plurality of adjacent detector modules. On the one hand, the individual detector modules are fixed mechanically on a module carrier and, on the other hand, electrical contact is made between them and a printed circuit board via a plug-in connection.

Each detector module has a so-called module head, on which detector elements are arranged, which are lined up to form columns and rows, for the purpose of producing output signals which are a measure for the attenuation of X-ray radiation emitted by an X-ray source and passing through a measurement region. The respective module head of the detector module is held mechanically on the module carrier and is aligned in relation to the X-ray source such that a defined part of the measurement region is sensed by the respective detector module.

The electrical connection between the detector module and the printed circuit board can be produced by way of a module plug, which is connected to the module head via flexible conductor tracks in the form of a flexible cable. In this case, a fixedly defined slot on the printed circuit board is associated with each detector module or each module plug.

When the electrical connection is produced, the output signals from the detector module which are produced by the detector elements are transmitted to the printed circuit board. Initial preprocessing of the output signals takes place there. In order to carry out the preprocessing, an analog-to-digital converter and a data acquisition unit are associated with each detector module on the printed circuit board, the analog-to-digital converter being in the form of a separate plug-in card in the case of the detectors used to date for computer tomographs.

Existing defects, or defects occurring during operation of the detector, on the detector module or the analog-to-digital converter result in faults in the conditioned output signal from a detector element, in which case it is not possible, on the basis of the faulty output signal, to draw any conclusions as to whether the fault originates from a defect in the analog-to-digital converter or a defect in the detector module.

Until now, the fault has been localized by two adjacent plug-in cards simply being inserted the other way around and by a further measurement of the faulty output signal, in which case the plug-in card of the possibly defective analog-to-digital converter has been replaced by a plug-in card of an adjacent fault-free analog-to-digital converter. The faulty output signal is caused by a defect on the plug-in card of the analog-to-digital converter when the fault is transferred to the changed position of the plug-in card, i.e. when the fault is “carried along” with the plug-in card. In the reverse case, if the fault is observed at the same position irrespective of the plug-in cards being exchanged, the plug-in card of the analog-to-digital converter was fault-free. In this situation, it is highly probable that the detector module is defective, with the result that targeted correction of the detector can be carried out.

In the case of the detectors of the newer generation, however, the analog-to-digital converter is integrated directly on the printed circuit board, with the result that it is not possible to localize a faulty assembly by simply exchanging plug-in cards.

### SUMMARY

One object of at least one embodiment of the present invention is to specify an auxiliary device for a detector, which includes a plurality of detector modules which can be brought into contact with a printed circuit board, or a method for carrying out faultfinding on a detector having such an auxiliary device, with which method simple faultfinding of a defective component of the detector is possible.

Faultfinding of a defective component of the detector is also possible, for example, if, instead of the analog-to-digital converters, the detector modules are exchanged on a module carrier. Faultfinding would be successful in the same way by use of a second measurement, in which it is determined whether the faulty output signal is transferred to the changed position of the detector module.

However, the inventors have recognized that exchanging the detector modules for faultfinding purposes is disadvantageous for a plurality of reasons. Exchanging the detector modules on a module carrier firstly alters the alignment or position of the detector modules with respect to an X-ray source, with the result that reproducible output signals from the detector modules cannot be produced. The output signals which are different from the original measurement make determination of the faulty output signals and thus correct localization of the defective component of the detector more difficult. Secondly, detaching and fixing detector modules on the module carrier is associated with considerable complexity.

Inserting the module plugs of the detector modules on adjacent slots of the printed circuit board the other way around is physically impossible because the conductor tracks can be guided flexibly in the longitudinal direction of the conductor tracks but have a high degree of rigidity perpendicular to the longitudinal axis.

Simple faultfinding for a faulty component of the detector is possible according to at least one embodiment of the invention by use of an adapter which has module-side contact-making device(s) for the purpose of producing a detachable electrical connection with at least two detector modules and board-side contact-making device(s) for the purpose of producing a detachable electrical connection with at least two slots of the printed circuit board, when each electrical connection is produced the first slot of the printed circuit board being electrically connected to the second detector module, and the second slot of the printed circuit board being electrically connected to the first detector module, with the result that diagonally opposing contact is made between the detector modules and the slots in the case of an essentially unchanged geometrical alignment or position with respect to an X-ray source.

It is possible in a simple manner with the adapter according to at least one embodiment of the invention to check, in two successive measurements, whether a defect is present on the detector module or whether a defect is present in signal-processing electronics associated with the detector module. Owing to the use of the adapter, it is not necessary to exchange any components on the detector. Faultfinding is thus in particular also possible when the respective analog-to-digital converter of a detector module is integrated in the printed circuit board.

Faultfinding in the case of the detector having the adapter according to at least one embodiment of the invention typically includes the following method steps:
a) carrying out a first measurement during an operation of the detector for identifying the first detector module, which has a faulty output signal;
b) detaching the connection of the first detector module from a first slot of the printed circuit board and of an adjacent second detector module from a second slot of the printed circuit board;
c) plugging the adapter onto the printed circuit board such that the board-side contact-making device(s) of the adapter are connected to the two slots of the printed circuit board which have become free;
d) plugging the two detector modules onto the adapter such that the module-side contact-making device(s) of the adapter are connected to the detector modules in the case of an essentially unchanged geometrical alignment with respect to an X-ray source;
e) carrying out a second measurement during an operation of the detector for identifying the detector module which has a faulty output signal.

In one advantageous refinement of at least one embodiment of the invention, the adapter has at least one fixing device for the purpose of producing a detachable mechanical connection with the printed circuit board, with the result that it is possible to carry out a check on the detector having the adapter according to at least one embodiment of the invention even at high rotational speeds of the detector, without there being any risk of detachment. Owing to the fixing device provided, secure electrical contact is also ensured between the board-side contact-making device(s) of the adapter and the slots of the printed circuit board, with the result that signal interference owing to, for example, microphonics is avoided. The fixing device is preferably a screw, and the mechanical connection is a screw connection.

Spacers are advantageously arranged on the adapter which bear essentially without a gap against directly adjacent plug-in connections of the printed circuit board when an electrical connection is produced between the board-side contact-making device(s) of the adapter and the slots of the printed circuit board. Such spacers prevent signal interference which could be caused by oscillations of the adapter at high rotational speeds of the detector.

The module-side contact-making device(s) and the board-side contact-making device(s) are advantageously arranged on a carrier. The module-side contact-making device(s) are in this case preferably plugs, and the carrier-side contact-making device(s) are sockets.

### BRIEF DESCRIPTION OF THE DRAWINGS

Example embodiments of the invention and further advantageous refinements of the invention are illustrated in the following schematic drawings, in which:

FIG. 1 shows a view, which is partially perspective and partially in the form of a block diagram, of a computer tomograph having a detector, which includes a plurality of detector modules which can be brought into contact with a printed circuit board,

FIG. 2 shows a perspective view of a detail of the detector shown in FIG. 1, in which case two adjacent detector modules can be seen,

FIG. 3 shows a perspective view of an adapter according to at least one embodiment of the invention,

FIG. 4 shows a front view of the adapter according to at least one embodiment of the invention shown in FIG. 2,

FIG. 5 shows the detail shown in FIG. 2 of the detector with the adapter inserted, and

FIG. 6 shows a view in the form of a block diagram of a flowchart of a method for faultfinding on the detector shown in FIG. 1.

### DETAILED DESCRIPTION OF THE EXAMPLE EMBODIMENTS

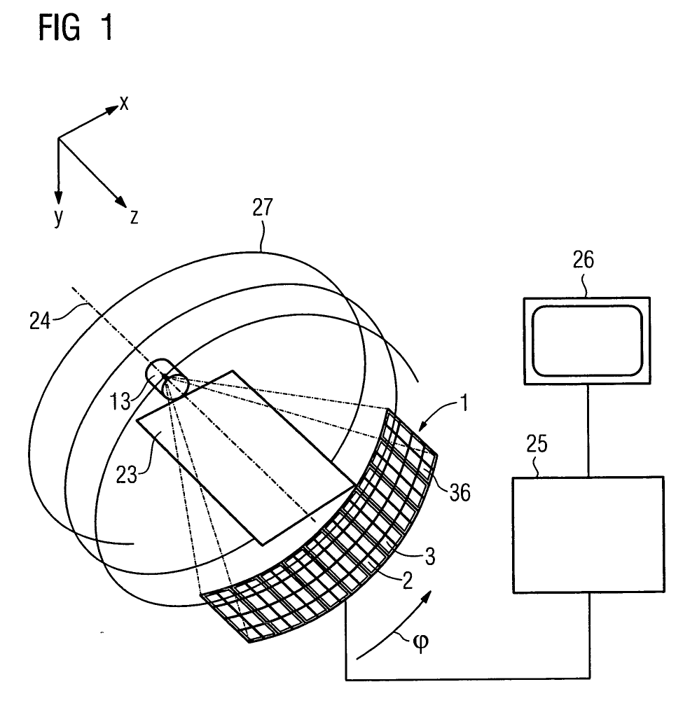

FIG. 1 shows a view, which is partially in the form of a block diagram and partially perspective, of a computer tomograph. A mounting apparatus for the computer tomograph includes a movable tabletop 23, by which an object to be investigated, for example a patient, can be moved through an opening in the housing of the computer tomograph into a measurement region of a recording system associated with the computer tomograph. The object and the measurement region of the recording system can thus be displaced in relation to one another.

The recording system has an X-ray source 13, for example an X-ray tube, and a detector 1, which is arranged opposite said X-ray source 13 and is formed from a plurality of detector modules 2, 3, which are arranged adjacent to one another in the φ (direction shown and of which two are provided with a reference symbol. Each detector module 2 or 3 includes a plurality of detector elements 36 lined up to form columns and rows. For reasons of clarity, only one of these detector elements 36 is provided with a reference symbol in FIG. 1.

The X-ray source 13 produces a fan-shaped X-ray bundle. The X-ray bundle passes through the object positioned in the measurement region of the recording system and impinges on the detector elements 36 of the detector 1. The detector elements 36 of the detector modules 2, 3 each produce an output signal which is dependent on the attenuation of the X-ray radiation passing through the measurement region.

The X-ray radiation is converted into measured values, for example, by way of a photodiode which is optically coupled to a scintillator or by way of a directly converting semiconductor. A set of output signals from all of the detector modules 2, 3 of the detector 1 which are recorded for a specific position of the X-ray source 13 in relation to the object is referred to as “projection”.

A gantry (not illustrated), on which the recording system is arranged, is located within the computer tomograph. The gantry can be rotated about the system axis 24 of the computer tomograph by way of a drive unit (not illustrated) at a high rotational speed. A large number of projections can thus be made from different projection directions of the object. Owing to a rotation of the gantry at the same time as a continuous advancing movement of the object in the direction of the system axis 24, in particular an investigation region of the object can be sampled which is greater than the measurement region formed by the recording system. The output signals, which are obtained from various projection directions during the helical sampling 27, of the object can be calculated by means of a computation unit 25 so as to form tomograms or volumetric images and can be represented visually for an operator on a display unit 26.

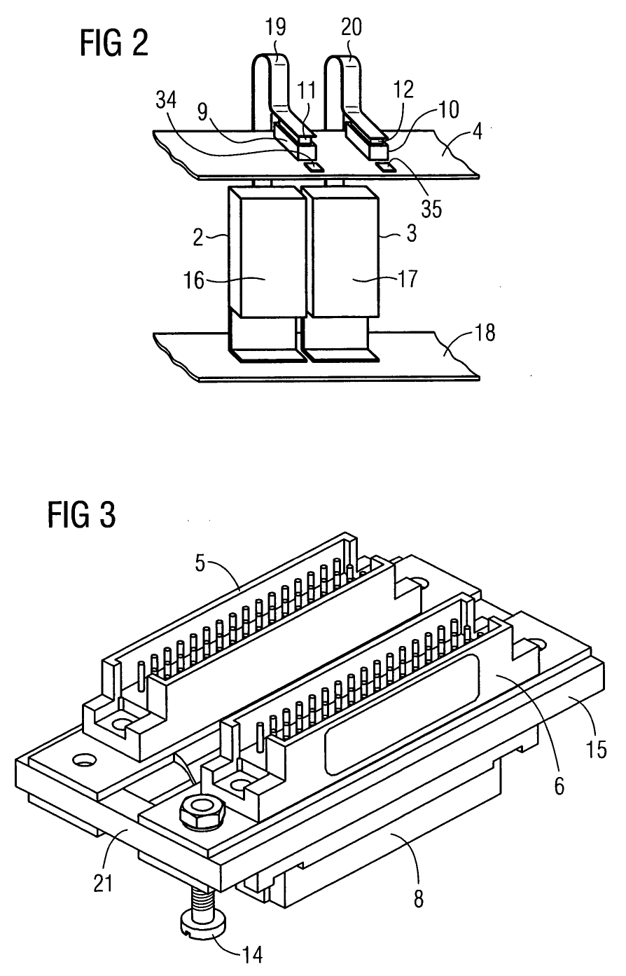

FIG. 2 shows a perspective view of a detail of the detector 1 shown in FIG. 1 with two adjacent detector modules 2, 3. The two detector modules 2, 3 are fixed mechanically on a module carrier 18 and electrical contact is made between them and a printed circuit board 4 via a plug-in connection. Each detector module 2 or 3 has a module head 16 or 17, on which a plurality of the detector elements, which are lined up to form columns and rows and are not visible here, are arranged, for the purpose of producing the output signals. The respective module head 16 or 17 of a detector module 2 or 3 is held mechanically on the module carrier 18 and is aligned in relation to the X-ray source 13 such that a defined part of the measurement region is sensed by the respective detector module 2 or 3.

The electrical contact between the respective detector module 2 or 3 and the printed circuit board 4 is produced by way of a module plug 11 or 12, which is connected to the module head 16 or 17 via flexible conductor tracks 19 or 20 in the form of a flexible cable. In this case, a fixedly defined slot 9 or 10 on the printed circuit board 4 is associated with each detector module 2 or 3 or each module plug 11 or 12.

The output signals from the detector module 2 or 3 which are produced by the detector elements are thus transmitted to the printed circuit board 4. Initial preprocessing of the output signals takes place there by way of signal-processing electronics 34 or 35 provided for each detector module 2 or 3. The respective signal-processing electronics 34 or 35 are in this case integrated in the printed circuit board 4 as well.

Existing defects, or defects occurring during operation of the detector 1, for example, on the first detector module 2 or the first signal-processing electronics 34, result in faults in the conditioned output signal from a detector element, in which case it is not possible, on the basis of the faulty output signal, to draw any conclusions as to whether the fault originates from a defect in the first signal-processing electronics 34 or a defect in the first detector module 2.

The adapter according to at least one embodiment of the invention makes possible simple and rapid faultfinding of the detector 1, without it being necessary to exchange components arranged on the detector 1. FIG. 3 shows a perspective view of an example embodiment of the adapter according to at least one embodiment of the invention. The adapter can be arranged between the module plugs 11, 12 of two adjacent detector modules 2, 3 and the two associated slots 9, 10 on the printed circuit board 4.

The adapter includes module-side contact-making device(s), in this case in the form of a plug 5 or 6, in each case, for the purpose of producing a detachable electrical connection with two detector modules 2, 3 and board-side contact-making device(s), in this case in the form of a socket 7 or 8 in each case, for the purpose of producing a detachable electrical connection with at least two slots 9, 10 of the printed circuit board 4. Owing to the perspective view, only the second board-side contact-making device(s) is visible. The module-side plugs 5, 6 and the board-side sockets 7, 8 are cross-connected to one another such that there is an electrical connection, on the one hand, between the first module-side plug 5 and the second board-side socket 8 and, on the other hand, between the second module-side plug 6 and the first board-side socket 7.

When each electrical connection is produced, the first slot 9 of the printed circuit board 4 is thus electrically connected to the second detector module 3, and the second slot 10 of the printed circuit board 4 is electrically connected to the first detector module 2, with the result that diagonally opposing contact is made between the detector modules 2, 3 and the slots 9, 10 in the case of an essentially unchanged geometrical alignment with respect to an X-ray source.

The module-side plugs 5, 6 and the board-side sockets 7, 8 are arranged on an insulating carrier 21. The carrier 21 may be manufactured, for example, from a plastic. A fixing device 14, in this case in the form of a screw, is provided on the carrier 21 such that it is possible for a mechanical connection, in this case in the form of a screw connection, to be produced between the adapter and the printed circuit board 4. When the mechanical connection is produced, faultfinding on the detector 1 having the adapter can be carried out even at high rotational speeds of the detector 1, without there being any risk of detachment. Furthermore, it is ensured that secure electrical contact is made between the adapter and the printed circuit board 4. Signal interference owing to, for example, microphonics is thus avoided.

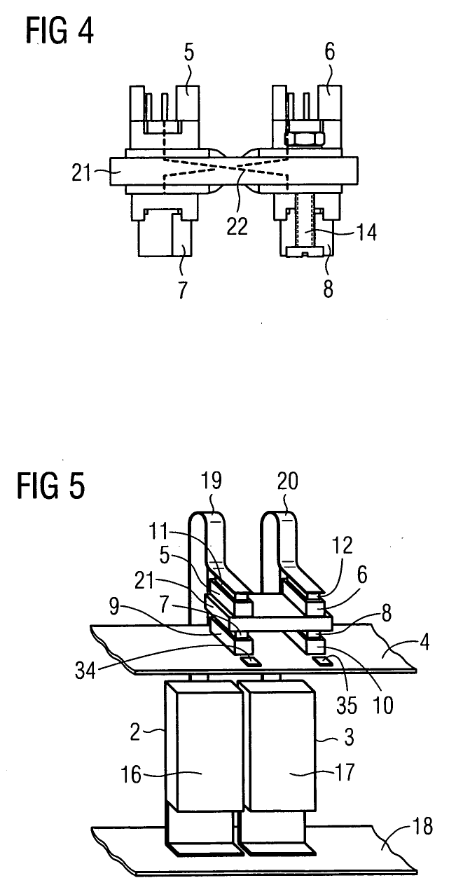

In addition, a spacer 15, for example in the form of a protruding edge, is arranged on the carrier 21 and serves the purpose of forming the distance from adjacent plug-in connections on the printed circuit board 4 such that it is as gap-free as possible. Owing to the gap-free arrangement when the adapter is plugged on, signal interference which is caused by oscillations of the adapter at high rotational speeds of the detector 1 is likewise reduced. In order to illustrate the electrical cross-connections between the module-side plugs 5, 6 and the board-side sockets 7, 8, the adapter from FIG. 3 is shown in a front view in FIG. 4. The connections can be realized, for example, by means of simple cable connections 22 which run through the carrier 21 of the adapter.

FIG. 5 shows the detail of the detector 1 shown in FIG. 2, but with the adapter being introduced between the module plugs 11, 12 of the detector modules 2, 3 and the slots 9, 10 of the printed circuit board 4. The electrical connection between the detector modules 2, 3 and the signal-processing electronics 34, 35 produced by the adapter device(s) that the output signals originating from the first detector module 2 are conditioned by way of the second signal-processing electronics 35, and the output signals originating from the second detector module 3 are conditioned by means of the first signal-processing electronics 34.

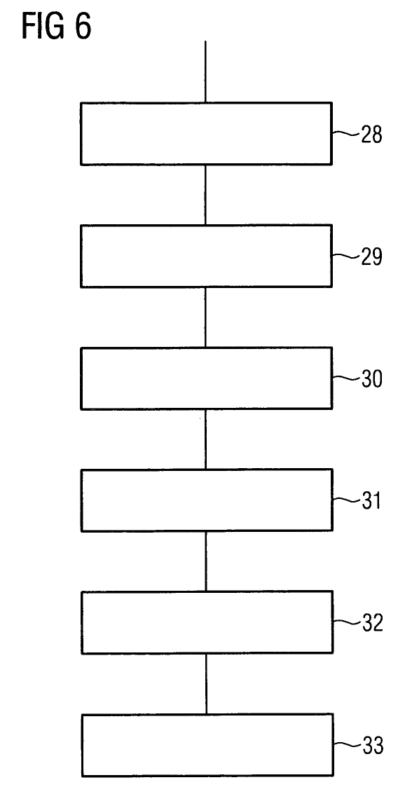

Faultfinding on the detector 1 having the adapter essentially includes the method steps illustrated in the form of a flowchart in FIG. 6:

In a first method step, a first measurement is carried out during an operation, for example during rotation of the detector 1, with the result that it is possible to identify the first detector module 2 which has a faulty output signal.

In a second method step, the connection between the first detector module 2 and a first slot 9 of the printed circuit board and between an adjacent second detector module 3 and a second slot 10 of the printed circuit board 4 is detached.

Subsequently, in a third method step, the adapter is plugged onto the printed circuit board 4, with the result that the board-side contact-making devices 7, 8 of the adapter are connected to the two slots 9, 10 of the printed circuit board 4 which have become free.

In the context of a fourth method step, the detector modules 2, 3 or the module plugs 11, 12 associated with these detector modules 2, 3 are plugged onto the adapter, with the result that the module-side contact-making devices 5, 6 of the adapter are connected to the detector modules 2, 3 in the case of an essentially unchanged geometrical alignment with respect to an X-ray source.

In a fifth method step, a second measurement is carried out during operation of the detector 1 in order that it is possible to identify the detector module 2 or 3 which has a faulty output signal.

In a final, sixth method step, a comparison of the measurement results from the first and the second measurements is carried out in order to localize the fault. If the faulty output signal moves between the first and the second measurements from the position of the first detector module 2 to the position of the second detector module 3, the first detector module 2 is defective. Otherwise, it can be assumed with a high degree of probability that there is a defect in the first signal-processing electronics 34.

The use of the adapter is essentially independent of the design of the detector modules. It would be conceivable, for example, for the adapter also to be used for detector modules in which in each case the module plug is arranged directly on the module head. It is naturally also possible to use the adapter when the printed circuit board is integrated directly on the module carrier for the purpose of making electrical contact with the detector modules.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An adapter for a detector including a plurality of detector modules to be brought into contact with a printed circuit board, the adapter comprising:
module-side contact-making means for producing a detachable electrical connection with at least two detector modules; and
board-side contact-making means for producing a detachable electrical connection with at least two slots of the printed circuit board, wherein when each electrical connection is produced, the first slot of the printed circuit board is electrically connected to the second detector module, and the second slot of the printed circuit board is electrically connected to the first detector module, with the result being that diagonally opposing contact is made between the detector modules and the slots in the case of an essentially unchanged geometrical alignment with respect to an X-ray source.

2. The adapter as claimed in claim 1, including at least one fixing means for producing a detachable mechanical connection with the printed circuit board.

3. The adapter as claimed in claim 2, wherein the fixing means is a screw, and the mechanical connection is a screw connection.

4. The adapter as claimed in claim 1, including spacers, which bear essentially without a gap against directly adjacent plug-in connections of the printed circuit board when an electrical connection is produced between the board-side contact-making means of the adapter and the slots of the printed circuit board.

5. The adapter as claimed in claim 1, including a carrier, on which the module-side contact-making means and the board-side contact-making means are arranged.

6. The adapter as claimed in claim 1, wherein the module-side contact-making means includes plugs.

7. The adapter as claimed in claim 1, wherein the carrier-side contact-making means includes sockets.

8. A method for carrying out faultfinding on a detector, including a plurality of detector modules to be brought into contact with a printed circuit board, and including an adapter as claimed in claim 1, the method comprising:
carrying out a first measurement during an operation of the detector for identifying the first detector module, which has a faulty output signal;
detaching the connection between the first detector module and a first slot of the printed circuit board and between an adjacent second detector module and a second slot of the printed circuit board;
plugging the adapter onto the printed circuit board such that the board-side contact-making means of the adapter are connected to the two slots of the printed circuit board which have become free;
plugging the two detector modules onto the adapter such that the module-side contact-making means of the adapter are connected to the detector modules in the case of an essentially unchanged geometrical alignment with respect to an X-ray source; and
carrying out a second measurement during an operation of the detector for identifying the detector module which has a faulty output signal.

9. The adapter as claimed in claim 2, including spacers, which bear essentially without a gap against directly adjacent plug-in connections of the printed circuit board when an electrical connection is produced between the board-side contact-making means of the adapter and the slots of the printed circuit board.

10. The adapter as claimed in claim 3, including spacers, which bear essentially without a gap against directly adjacent plug-in connections of the printed circuit board when an electrical connection is produced between the board-side contact-making means of the adapter and the slots of the printed circuit board.

11. The adapter as claimed in claim 2, including a carrier, on which the module-side contact-making means and the board-side contact-making means are arranged.

12. The adapter as claimed in claim 2, wherein the module-side contact-making means includes plugs.

13. The adapter as claimed in claim 2, wherein the carrier-side contact-making means includes sockets.

14. An adapter for a detector including a plurality of detector modules to be brought into contact with a printed circuit board, the adapter comprising:
at least one module-side contact-making device, providing a detachable electrical connection with at least two detector modules; and
at least one board-side contact-making device, providing a detachable electrical connection with at least two slots of the printed circuit board, wherein when each electrical connection is produced, the first slot of the printed circuit board is electrically connected to the second detector module, and the second slot of the printed circuit board is electrically connected to the first detector module, with the result being that diagonally opposing contact is made between the detector modules and the slots in the case of an essentially unchanged geometrical alignment with respect to an X-ray source.

15. The adapter as claimed in claim 14, including at least one fixing device, providing a detachable mechanical connection with the printed circuit board.

16. The adapter as claimed in claim 15, wherein the fixing device is a screw, and the mechanical connection is a screw connection.

17. The adapter as claimed in claim 14, including spacers, which bear essentially without a gap against directly adjacent plug-in connections of the printed circuit board when an electrical connection is produced between the at least one board-side contact-making device of the adapter and the slots of the printed circuit board.

18. The adapter as claimed in claim 14, including a carrier, on which the at least one module-side contact-making device and the at least one board-side contact-making device are arranged.

19. The adapter as claimed in claim 14, wherein the at least one module-side contact-making device includes plugs.

20. The adapter as claimed in claim 14, wherein the at least one carrier-side contact-making device includes sockets.
